(19) United States
(12) Patent Application Publication
(10) Pub. No.: US 2024/0212448 A1
(43) Pub. Date: Jun. 27, 2024

(54) CLOUD-BASED LOTTERY SYSTEM

(71) Applicant: IGT Global Solutions Corporation, Providence, RI (US)

(72) Inventors: Grahame Falvey, Oberpremstätten (AT); Karri Laitalainen, Warsaw (PL); Delash Patel, Watford (GB); Corey Edwards, Johnston, RI (US); Johan Berg, Solna (SE); Jukka Harju, Rome (IT)

(21) Appl. No.: 18/089,323

(22) Filed: Dec. 27, 2022

(51) Int. Cl. G07F 17/32

(52) U.S. Cl. CPC G07F 17/3258; G07F 17/3211; G07F 17/329

(57) ABSTRACT

A gaming system server, method, and system are provided. A method includes determining a lottery ticket corresponds to a winning lottery ticket, determining a prize associated with the winning lottery ticket includes a progressive prize, determining the lottery ticket corresponds to a type of lottery ticket that links a physical ticket prize pool with a digital ticket prize pool, in response to determining that the lottery ticket corresponds to the winning lottery ticket, includes the progressive prize, and corresponds to a type of lottery ticket that links a physical ticket prize pool with a digital ticket prize pool, referencing an electronic record of a progressive prize pool for linked tickets. The method may further include determining a current value of the progressive prize pool for linked tickets then assigning a prize value to the lottery ticket based on the current value of the progressive prize pool for linked tickets.

### BACKGROUND

The present disclosure is generally directed toward managing progressive lottery games, particularly using a cloud-based architecture.

Designers of games of chance often attempt to control both the size and frequency of payouts. Choosing the correct frequency and size of payouts can greatly increase the attractiveness of a game to a gaming customer. One way large payouts are made economically feasible is by the use of a progressive game. In a conventional progressive game, a portion of each wager in a base game is contributed to a progressive prize pool. Periodically, a player of the base game may win all or a portion of the accumulated progressive prize pool.

### BRIEF SUMMARY

In some embodiments, a gaming system server is provided that includes: at least one processor; and at least one memory device that stores instructions, which when executed by the at least one processor, cause the at least one processor to: determine a lottery ticket corresponds to a winning lottery ticket; determine a prize associated with the winning lottery ticket includes a progressive prize; determine the lottery ticket corresponds to a type of lottery ticket that links a physical ticket prize pool with a digital ticket prize pool; in response to determining that the lottery ticket corresponds to the winning lottery ticket, includes the progressive prize, and corresponds to a type of lottery ticket that links a physical ticket prize pool with a digital ticket prize pool, reference an electronic record of a progressive prize pool for linked tickets; based on referencing the electronic record of the progressive prize pool for linked tickets, determine a current value of the progressive prize pool for linked tickets; and assign a prize value to the lottery ticket based on the current value of the progressive prize pool for linked tickets.

In some embodiments, a method is provided that includes: determining, with a processor, a lottery ticket corresponds to a winning lottery ticket; determining, with the processor, a prize associated with the winning lottery ticket includes a progressive prize; determining, with the processor, the lottery ticket corresponds to a type of lottery ticket that links a physical ticket prize pool with a digital ticket prize pool; in response to determining that the lottery ticket corresponds to the winning lottery ticket, includes the progressive prize, and corresponds to a type of lottery ticket that links a physical ticket prize pool with a digital ticket prize pool, referencing an electronic record of a progressive prize pool for linked tickets; based on referencing the electronic record of the progressive prize pool for linked tickets, determining, with the processor, a current value of the progressive prize pool for linked tickets; and assigning, with the processor, a prize value to the lottery ticket based on the current value of the progressive prize pool for linked tickets.

In some embodiments, a system is provided that includes: a processor; and computer memory including instructions stored thereon that are executable by the processor, where the instructions include instructions that: automatically reference an electronic record of a progressive prize pool for linked tickets at a reference time in response to determining a lottery ticket: (1) corresponds to a winning lottery ticket, (2) includes a progressive prize, and (3) corresponds to a type of lottery ticket that links a physical ticket prize pool with a digital ticket prize pool; based on referencing the electronic record of the progressive prize pool for linked tickets, determine a value of the progressive prize pool for linked tickets at the reference time; assign a prize value to the lottery ticket based on the value of the progressive prize pool for linked tickets at the reference time; automatically update an electronic record associated with the lottery ticket to include the prize value assigned thereto; and automatically decrease the progressive prize pool for linked tickets by the prize value.

Additional features and advantages are described herein and will be apparent from the following Description and the figures.

### BRIEF DESCRIPTION OF THE SEVERAL VIEWS OF THE DRAWINGS

FIG. 1 is a block diagram of a system in accordance with embodiments of the present disclosure;

FIG. 2 is a block diagram of a system architecture in accordance with embodiments of the present disclosure;

FIG. 3 is a block diagram depicting another view of a system architecture in accordance with embodiments of the present disclosure;

FIG. 4 is a block diagram depicting yet another view of a system architecture in accordance with embodiments of the present disclosure;

FIG. 5 is a flow diagram depicting a first method in accordance with embodiments of the present disclosure;

FIG. 6 is a flow diagram depicting a second method in accordance with embodiments of the present disclosure;

FIG. 7 is a flow diagram depicting a third method in accordance with embodiments of the present disclosure;

FIG. 8 is a block diagram illustrating a message exchange used to implement a cloud-based multi-jurisdictional game in accordance with embodiments of the present disclosure; and

FIG. 9 is a block diagram illustrating a process for setting up a multi-jurisdictional progressive system in accordance with at least some embodiments of the present disclosure.

### DETAILED DESCRIPTION

Embodiments of the present disclosure provide an ability to administer a game or multiple games of chance, such as a lottery game, instant win scratch game, keno game, etc. The game(s) may be administered using a cloud-based architecture and may further be administered across multiple jurisdictions, each of which may have different regulations associated therewith.

As used herein, the term “jackpot” or “progressive jackpot” may refer to any large prize (e.g., monetary or cash prize) in a game or lottery, especially one that accumulates until it is won. A jackpot, in some embodiments, may refer to a largest possible prize available to a player of a game. As will be described herein, a winning ticket may have access to different progressive prizes, depending upon the type of the winning ticket. In some embodiments, a winning ticket may have a progressive prize value assigned thereto from a single progressive prize pool associated with a single jurisdiction (e.g., under regulation of an individual jurisdiction). In some embodiments, a winning ticket may have a progressive prize value assigned thereto from a combined progressive prize pool, which represents a combination of progressive prize values from two or more individual progressive prize pools (e.g., which may be associated with different jurisdictions).

One aspect of the present disclosure is to provide a cloud-based infrastructure that delivers a progressive prize jackpot controller to multiple jurisdictions and/or multiple channels. The proposed cloud-based architecture can further provide a multi-jurisdictional, multi-channel jackpot system as a service that can be sub-divided between different entities wishing to provide a jackpot for use in gaming.

Another aspect of the present disclosure is to provide a mechanism that allows a jackpot provider to create, configure, and control a jackpot (e.g., a progressive jackpot) for the purpose of providing access to that jackpot to other gaming providers (e.g., different jackpot providers and/or participants), specifically outside the jackpot provider's individual jurisdiction.

Another aspect of the present disclosure is to provide a mechanism that allows a jackpot provider set up access allowing jackpot participants to participate in a specific jackpot.

Another aspect of the present disclosure is to allow a jackpot provider and/or participant to enroll their devices into a specific jackpot to which they have access. It may also be possible for a jackpot provider and/or participant to purchase tickets for a game without requiring a direct link with their device. For instance, digital tickets for a progressive game may be purchased in a jurisdiction, using a purchasing platform provided by one game provider, and the digital tickets may have the ability to win a jackpot from another jurisdiction or from a jackpot pool that combines progressive contributions from a plurality of jurisdictions.

Another aspect of the present disclosure is to provide a mechanism that allows a jackpot participant to access the current and historical status of a jackpot to which they have access, specifically for the purposes of determining current jackpot levels, history of jackpot awards, and to which devices those awards have been awarded. In other embodiments, jackpots may be awarded to a particular digital ticket. In other embodiments, jackpots may be awarded by a multi-jurisdictional server to a jurisdictionally-unique server, so that the jurisdictionally-unique server can award the jackpot to a winning ticket.

Another aspect of the present disclosure is to provide a mechanism that allows a person, device, or individual ticket to register participation in a jackpot and provide its contribution of that participation based on the amount wagered.

Another aspect of the present disclosure is to provide a mechanism that allows a device to receive a current jackpot value from a combined progressive prize pool and to further receive an automated notification that the jackpot value has been transferred to a winning ticket, a winning jurisdiction, a winning device, or the like.

Another aspect of the present disclosure is to provide a mechanism that allows a device to register the triggering of a given jackpot with the centralized jackpot controller.

Another aspect of the present disclosure is to provide a mechanism that enables a centralized jackpot controller to calculate the awarded jackpot value taking into account the wagered value when the jackpot trigger was registered (e.g., upon receipt of the winning ticket number).

Another aspect of the present disclosure is to provide a mechanism that enables the centralized jackpot controller to award a jackpot value from a combined progressive pool based on a first-in first-out basis.

Another aspect of the present disclosure is to offer multi-jurisdictional progressive jackpots to games of the same type or games of different types from one or more different jurisdictions. The games may be accessed via a shared service (e.g., SaaS or cloud architecture). In some embodiments, the game(s) may correspond to lottery games, instant purchase and win games, scratch games, keno games, etc. Additional details of multi-vendor progressive gaming systems are described in US20120149452 to Cahill et al., the entire contents of which are hereby incorporated herein by reference.

In some embodiments, each participating jurisdiction may be allowed to maintain their existing suite of branded games, but some of those jurisdictionally-unique games would be allowed to participate in the combined progressive. As an example, a ticket may be of a type that links it with a jurisdictionally-unique progressive prize pool and that also links it with a combined progressive prize pool. In some embodiments, the ticket linked with the combined progressive prize pool may also be of the type that links a physical ticket prize pool with a digital ticket prize pool (e.g., the ticket may have access to a prize pool that is accessible to physical tickets and that is accessible to digital tickets). In some embodiments, the combined progressive prize pool may correspond to the prize pool that links at least one physical ticket prize pool with at least one digital ticket prize pool. The physical ticket prize pool may be associated with one jurisdiction and the digital ticket prize pool may be associated with a different jurisdiction or may be associated with the same jurisdiction as the physical ticket prize pool. Tickets that are allowed access to the combined progressive prize pool may be only allowed access to the combined progressive prize pool or may also be allowed to win a prize from a jurisdictionally-unique prize pool.

In some embodiments, each jurisdictionally-unique progressive jackpot will increase in real-time or near-real-time as participating games are sold by the participating lotteries of each jurisdiction.

In some embodiments, each participating lottery jurisdiction is requested and required to adhere to a predefined, common jackpot grid definition for the combined progressive prize pool, but may vary the presentation in their jurisdiction (e.g., Country, State, County, City, etc.).

In some embodiments, when a player wins the progressive jackpot from the combined progressive prize pool, the jackpot for the combined progressive prize pool will adjust to a new amount based on win.

In some embodiments, a jackpot as a service is provided that can be managed by one governing sponsor lottery or other legal entity similar to other multi-jurisdictional games. Appropriate reporting and management tools are provided to the governing lottery/entity.

In some embodiments, the jackpot as a service and the server(s) supporting the same may allow for multiple concurrent progressive jackpots to be offered to multiple participating lotteries. The server(s) supporting the multi-jurisdictional prize pool (e.g., the combined progressive prize pool) may adhere to the following rules: (1) the jackpot value (e.g., the current value of the combined progressive prize pool) will accumulate based on all sales from participating lotteries in near real time; (2) it is acceptable for the accumulation to be behind actual sales by a predetermined amount of time (e.g., 1 minute); (3) in the event of a wager being determined to win the jackpot from the combined progressive prize pool, the jackpot is calculated based on the accumulated sales as at the time the jackpot service receives the request (this value may exclude sales based on the acceptable limit from (2) above; (4) if server(s) of a participating lottery (e.g., from a particular jurisdiction) cannot communicate for a configurable amount of time (e.g., approximately 1 second), sales of tickets from that jurisdiction and/or other jurisdictions will be suspended until the connection is re-established.

In some embodiments, the server(s) managing the centralized progressive prize pool may provide the following data to each of the server(s) managing games of individual jurisdictions in near-real-time (e.g., every minute): (1) current jackpot(s) and (2) sales counts and amounts.

In some embodiments, the server(s) managing the centralized progressive prize pool may be configured to log and store transactional and jackpot information for reporting and audit purposes. These server(s) may serve as the system of record for the final jackpot and may support a method for balancing sales across participating systems.

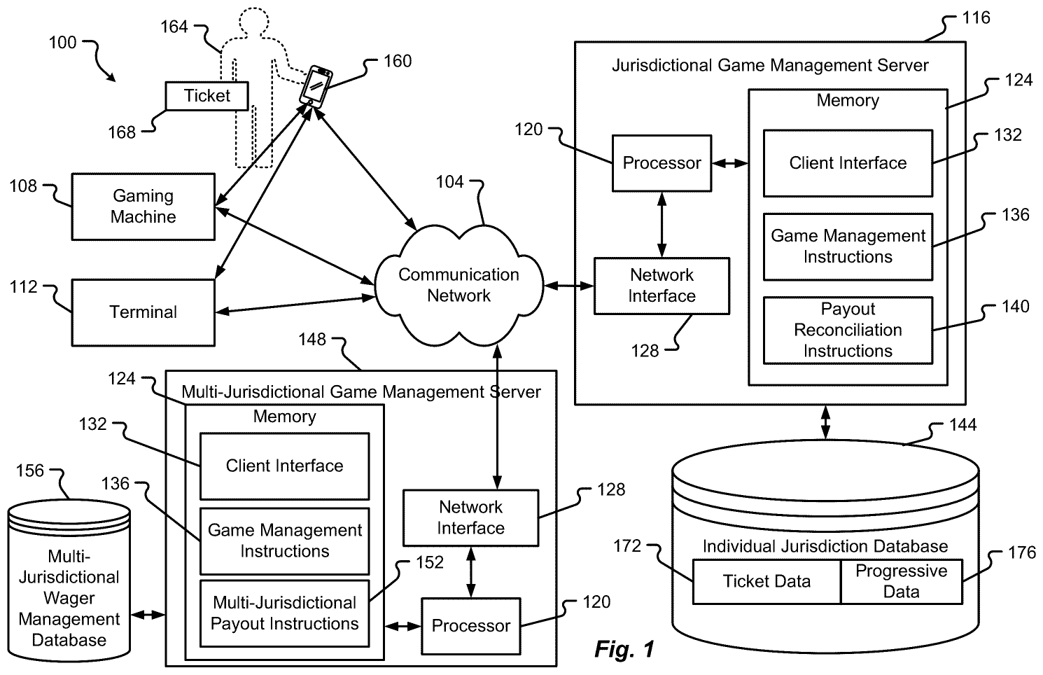

With reference initially to FIG. 1, details of an illustrative system 100 will be described in accordance with at least some embodiments of the present disclosure. The system 100 may be configured as a cloud-based lottery system or similar type of system configured to provide a multi-jurisdictional and/or multi-channel game of chance with access to one or more progressive prize pools. The components of the system 100, while depicted as having particular instruction sets and devices, is not necessarily limited to the examples depicted herein. Rather, a system according to embodiments of the present disclosure may include one, some, or all of the components depicted in the system 100 and does not necessarily have to include all of the components in a single device. For instance, the components of a server may be distributed amongst a plurality of servers and/or other devices (e.g., a gaming machine, a terminal, a mobile device, etc.) in the system 100 without departing from the scope of the present disclosure.

The system 100 is shown to include a communication network 104 that interconnects and facilitates machine-to-machine communications between one or multiple gaming machines 108, a terminal 112, a jurisdictional game management server, and a multi-jurisdictional game management server 148. It should be appreciated that the communication network 104 may correspond to one or many communication networks without departing from the scope of the present disclosure. In some embodiments, the various gaming machines 108 and server(s) 116, 148 may be configured to communicate using various nodes or components of the communication network 104. The communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, gaming machines 108, terminals 112, and other devices described herein may be distributed throughout one or multiple different jurisdictions (e.g., countries, states, counties, cities, etc.), which may or may not be subject to different gaming regulations. In some embodiments, the gaming machines 108 and terminals 112 may be distributed among a plurality of different locations. Gaming machines 108, terminals 112, and mobile devices 160 may correspond to specific but non-limiting examples of a gaming device.

In a situation where the gaming machines 108 and terminals 112 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, UMTS, LTE, 5G, variants thereof, etc.

The gaming machines 108, as one example of a gaming device, may utilize the same or different types of communication protocols to connect with the communication network 104. It should also be appreciated that different gaming machines 108 may or may not present the same type of game to a player 164. Likewise, terminals 112, as another example of a gaming device, may or may not enable the player 164 to wager on the same types of games, tickets, etc. as compared to the games made available via the gaming machine 108. It should also be appreciated that the servers 116, 148 may or may not be co-located with one or more gaming machines 108 or terminals 112 in the same property, premises, and/or jurisdiction. Thus, one or more gaming machines 108 may communicate with the multi-jurisdictional game management server 148 over a WAN, such as the Internet. Likewise, one or more terminals 112 may communicate with the jurisdictional game management server 116 and/or multi-jurisdictional game management server 148 over a WAN. These same devices may communicate with the jurisdictional game management server 116 via a WAN or LAN, depending upon the configuration of the system 100. In the event that a WAN or similar type of untrusted communication network 104 is used between components, a tunneling protocol or Virtual Private Network (VPN) may be established over some of the communication network 104 to ensure that communications between nodes within a jurisdiction/gaming/wagering location and a remotely-located node are secured.

The gaming machines 108 may correspond to a type of gaming device that enables player 164 interaction in connection with playing games of chance, games of skill, hybrid games of chance/skill, and/or place wagers on selected games (e.g., lottery games, keno games, scratch games, instant win games, instant purchase and win games, etc.). As used herein, an instant purchase and win game may correspond to a game in which a ticket for the game is pre-printed before purchase or a game in which a ticket for the game is printed at the time of purchase. In other words, the game may correspond to a type of game in which the machine generating the ticket uses an output of a random number generator to generate ticket numbers at the time of purchase. The game may alternatively correspond to a type of game in which the machine does not generate a ticket, but instead distributes pre-generated tickets.

Terminal-generated games can span a range of mechanics similar to scratch tickets from extended-play styles like Crossword and Bingo to quick-win games such as key-number match. And like scratch tickets, instant purchase and win tickets are immediately redeemable by the player, with similar odds and payout designs. But instant purchase and win games differ from other counterparts in some fundamental ways: many of the top prizes are jackpot-based; the games reside in the terminal rather than being visibly displayed on a retail counter; and playing them doesn't require the removal of a scratch coating. It should be appreciated that any type of game known or yet to be developed may employ a multi-jurisdictional jackpot approach as depicted and described herein.

The gaming machine 108 may also be configured as a terminal at which the player 164 can redeem a ticket 168. As will be discussed in further detail herein, the ticket 168 may correspond to a physical object or data object (e.g., electronic record stored in memory of the player's 164 mobile device 160) that is initially created by the jurisdictional game management server 116. The ticket 168, when identified as a winning ticket, may have a value assigned thereto and may be redeemable at a gaming machine 108, terminal 112, and/or other type of device. As mentioned above, the ticket 168 may correspond to a physical ticket or a digital ticket. In some embodiments, a ticket 168 may assume both a physical and digital form. For example, the ticket 168 may include a digital ticket 168 that is linked with a physical ticket by referencing an identification number of the physical ticket within part of the digital ticket's data.

The terminal 112 may also correspond to a gaming device that enables a player 164 to place wagers on events, games, and to redeem winning tickets 168. The terminal 112 may or may not enable the player 164 to purchase physical tickets 168 and/or digital tickets for one or a number of different games of chance

The player 164 may also be allowed to purchase a digital ticket 168 for a game of chance via their mobile device 160. In some embodiments, the mobile device 160, may operate as a remote control for a gaming machine 108 or wager terminal 112. In other embodiments, the mobile device 160 may operate similarly to a gaming machine 108 (e.g., by executing a local gaming application or by enabling a web-based interaction with a gaming application) and/or terminal 112 (e.g., by executing a local wager application or by enabling a web-based interaction with game management instructions 136 at one or more servers 116, 148). A mobile device 160 may correspond to a player's 164 personal device or to a device issued to the player 164 by a game provider. It should be appreciated that the player 164 may play games directly on their mobile device 160 and/or the mobile device 160 may be in communication with a gaming machine 108 or terminal 112 such that the mobile device 160 provides the interface for the player 164 to the gaming machine 108 or terminal 112. As shown in FIG. 1, the mobile device 160 may be in communication with the communication network 104 or in direct communication (e.g., via Bluetooth®, WiFi, NFC, etc.) with a gaming machine 108 or terminal 112. In a situation where the mobile device 160 is in direct communication with the gaming machine 108 or terminal 112, a proximity-based communication protocol such as Bluetooth®, WiFi, NFC, or the like, may be used to establish a proximity-based communication channel between the devices. Non-limiting examples of a mobile device 160 include a cellular phone, a smart phone, a tablet, a wearable device, an augmented reality headset, a virtual reality headset, a laptop, a Personal Computer (PC), or the like. As will be described herein, the jurisdictional game management server 116 and/or multi-jurisdictional game management server 148 may enable the player 164 to purchase tickets 168 for a game (or multiple games) in a physical and/or digital format. The servers 116, 148 may also enable the player 164 to access multi-jurisdictional games in which prizes from a combined progressive pool are available.

The jurisdictional game management server 116 is shown to include a processor 120, memory 124, and a network interface 128. These resources may enable functionality of the jurisdictional game management server 116 as will be described herein. For instance, the network interface 128 provides the jurisdictional game management server with the ability to send and receive communication packets or the like over the communication network 104. The network interface 128 may be provided as a network interface card (NIC), a virtual interface, a network port, drivers for the same, and the like. Communications between the components of the jurisdictional game management server and other devices connected to the communication network 104 may all flow through the network interface 128.

The processor 120 may correspond to one or many computer processing devices. For instance, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), a CPU core, a thread on a CPU core, a virtualized processor, a Graphics Processing Unit (GPU), combinations thereof, or plurality of microprocessors that are configured to execute the instructions sets stored in memory 124. Upon executing the instruction sets stored in memory 124, the processor 120 enables various functions of the jurisdictional game management server 116.

The memory 124 may include any type of computer memory device or collection of computer memory devices. The memory 124 may be volatile or non-volatile in nature and, in some embodiments, may include a plurality of different memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. In some embodiments, the memory 124 of the jurisdictional game management server 116 may include instructions that enable the processor 120 to store, manage, and interact with data stored in a database 144. The instructions stored in memory 124 that provide this capability are shown as a client interface 1332, game management instructions 136, and payout reconciliation instructions 140.

When executed by the processor 120, the client interface 132 may enable a player 164 to interact with the jurisdictional game management server 124 (e.g., purchase tickets 168, redeem tickets 168, check a status of tickets 168, etc.). The client interface 132 may provide a capability for the player 164 to view information at the jurisdictional game management server 116 via a client device, the mobile device 160, a terminal 112, or the like. Thus, the client interface 132 may include one or more webpages that are accessible by a client device and/or an application interface that enables an application on a mobile device 160 to view data available at the jurisdictional game management server 116.

The game management instructions 136, when executed by the processor 120, may enable the jurisdictional game management server 116 to implement one or more games and apply one or more game rules specific to a particular jurisdiction. The game management instructions 136 at the jurisdictional game management server 116 may also enable the game management server 116 to interact with game management instructions 136 of a multi-jurisdictional game management server 148, thereby enabling players 164 in a particular jurisdiction to access a prize pool available to a plurality of jurisdictions. The game management instructions 136 may interact with payout reconciliation instructions 140 to determine when a player's ticket 168 corresponds to a winning ticket and to determine a value associated with the winning ticket. In some embodiments, when a ticket is identified as a winning ticket by the game management instructions 136, the payout reconciliation instructions 140 may be invoked to determine a winning value associated with the winning ticket. In some embodiments, the payout reconciliation instructions 140 may reference the individual jurisdiction database 144 to determine a current value of a prize pool for that particular jurisdiction (e.g., a jurisdictionally-unique progressive prize pool). In some embodiments, the payout reconciliation instructions 140 may also include instructions for determining when information describing a winning ticket was received at the jurisdictional game management server 116. As will be described in further detail herein, a prize value based on an individual jurisdiction's progressive prize pool may depend upon ticket purchases within that jurisdiction and a cumulative value of the progressive prize pool for that jurisdiction. The prize value may also depend upon the purchase value of the ticket 168. Such information may be maintained in the individual jurisdiction database 144 as ticket data 172 and progressive data 176.

The ticket data 172 may include information describing tickets 168 purchased within a particular jurisdiction. The ticket data 172 may also indicate wager amounts associated with purchased tickets, a type of ticket (e.g., whether the ticket 168 is a physical ticket, a digital ticket, and/or a ticket linked with a combined progressive prize pool). In other words, the ticket data 172 may inform whether or not a ticket 168 corresponds to a type of ticket that is qualified to only win a prize from a jurisdictional progressive prize pool or whether the ticket 168 corresponds to a type of ticket that is qualified to win a prize from a combined progressive prize pool. If the ticket 168 is of a type that links a physical ticket prize pool with a digital ticket prize pool (e.g., is enrolled in a multi-channel and/or multi-jurisdictional game), then the ticket 168 may be allowed to access prize values from a combined progressive prize pool. In such a situation, the game management instruction 136 may cause the jurisdictional game management server 116 to interact with the multi-jurisdictional game management server 148 to determine a winning value for the ticket 168.

The multi-jurisdictional game management server 148 may include components similar to the jurisdictional game management server 116. For instance, the multi-jurisdictional game management server 148 may include a process 120, memory 124, and a network interface 128. The multi-jurisdictional game management server 148 may also include client interface 132 instructions and game management instructions 136. The game management instructions 136 of the multi-jurisdictional game management server 148 may coordinate compliance of jurisdictional game management servers 116 with a multi-jurisdictional game and/or multi-channel game. In other words, the game management instructions 136 of the servers 116, 148 may enable players 164 to participate in games unique to a jurisdiction as well as games that extend across multiple jurisdictions.

The multi-jurisdictional payout instructions 152, similar to the payout reconciliation instruction 140, may be invoked by the game management instructions 136 to determine a prize value associated with a winning ticket. The multi-jurisdictional payout instructions 152, may reference the multi-jurisdictional wager management database 156 to determine a current value of a combined progressive prize pool. More specifically, and without limitation, the multi-jurisdictional payout instructions 152 may be configured to, in response to determining that a ticket 168 corresponds to the winning ticket (e.g., a winning lottery ticket), includes a progressive prize, and corresponds to a type of ticket that links a physical ticket prize pool with a digital ticket prize pool (e.g., was purchased with a link to a multi-jurisdictional game), reference an electronic record of a progressive prize pool for linked tickets. The progressive prize pool referenced in this process may correspond to a multi-jurisdictional progressive prize pool or a jurisdictionally-unique progressive prize pool. The multi-jurisdictional payout instructions 152 may then determine a current value of the progressive prize pool for linked tickets and assign a prize value to the winning ticket based on the current value of the progressive prize pool for linked tickets.

Although depicted as a separate database, any of the information stored in the database 144 may be stored in memory 124 of the jurisdictional game management server 116, in memory 124 of the multi-jurisdictional game management server 148, in memory of the mobile device 160, in the multi-jurisdictional wager management database 156, or combinations thereof. In other words, the data structures described as being maintained in the database 144 do not necessarily need to solely reside within the database 144, but rather can be distributed among memory devices of other components in the system 100.

The game management instructions 136, when executed by the processor 120, may enable one or both servers 116, 148 to perform any task associated with generating/creating, storing, organizing, analyzing, or reporting events related to a ticket 168. The game management instructions 136 may also be configured to enable data logging, reporting, and data exchanges between various nodes of the system 100. In other words, the game management instructions 136 may be configured to interact with other devices for purposes of regulatory compliance, for purposes of administering the multi-jurisdictional game, for purposes of administering a jurisdictionally-unique game, or combinations thereof.

The multi-jurisdictional game management server 148 is depicted as being separate from the jurisdictional game management server 116, but it should be appreciated that a single server can be configured with the capabilities of both servers 116, 148.

The game management instructions 136, when executed by the processor 120, may enable a server 116, 148 to manage the various games played by a player 164, regardless of whether the player 164 is purchasing tickets 168 for the game as physical tickets (e.g., from a terminal 112) or as digital tickets (e.g., from mobile device 160). The game management instructions 136 may track wagers placed by the player 164 at a gaming machine 108, terminal 112, and/or mobile device 160 and may help store information related to such wagers in either database 144, 156. The game management instructions 136 may also track tickets 168 purchased by players 164 and information associated with such tickets (e.g., ticket data 172). The type of information associated with a ticket that may be tracked by the game management instructions 136 may include, ticket identification numbers (e.g., ticket ID or ticket serial number), ticket wager value, game(s) associated with the ticket, ticket type (e.g., whether associated with a progressive prize or not, whether associated with a single jurisdictional prize or a multi-jurisdictional prize, whether associated with a prize pool that links digital tickets and physical tickets, whether a ticket is a winning ticket, whether a ticket has been redeemed, when a ticket was purchased, when information regarding a ticket purchase was received at a server 116, 148, etc.). In some embodiments, the game management instruction set 152 may also be configured to track a status of wager events (e.g., sporting events, race events, bingo, keno, lottery, etc.), whether a player 164 has placed a wager on such events, and what type of device was used to purchase such tickets 168.

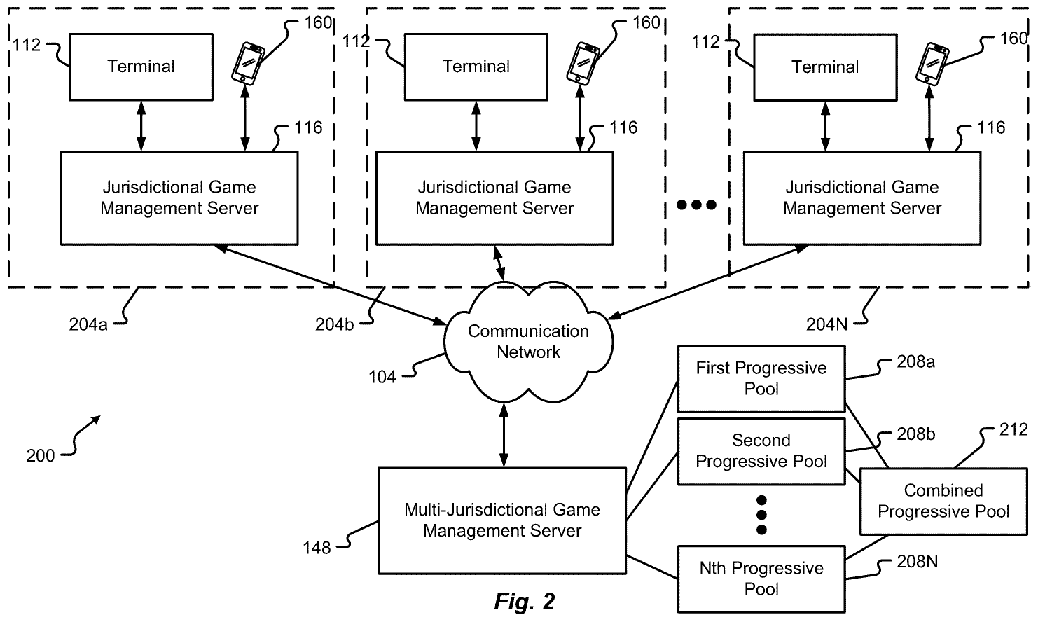

With reference now to FIG. 2, additional details of cloud-based architecture 200 used within the context of the system 100 will be described in accordance with at least some embodiments of the present disclosure. The architecture 200 may include a plurality of jurisdictions 204, 204b, . . . , 204N, each of which are allowed to administer their own jurisdictionally-unique games. Examples of such games can include lottery games, instant win games, scratch games, FastPlay games, games of chance, games of skill, hybrid games of chance/skill, event wagers, etc. As can be appreciated, each jurisdiction 204a, 204b, 204N may include one or more independent jurisdictional game management servers 116 that communicate with various devices to facilitate ticket 168 purchases via one or more different channels. In some embodiments, some jurisdictions 204a, 204b, 204N may only enable physical ticket purchases whereas other jurisdictions 204a, 204b, 204N may only enable digital ticket purchases. Some jurisdictions 204a, 204b, 204N may enable the purchase of digital and physical tickets. The purchase of such tickets may be managed individually by each jurisdictional game management server 116, but the redemption of winning tickets 168 and assignment of values there to may be coordinated by servers 116, 148 if the ticket 168 is associated with a prize pool made available to different types of games or made available to multiple jurisdictions.

In accordance with at least some embodiments, the jurisdictional game management servers 116 may coordinate with a multi-jurisdictional game management server 148 to enable players 164 to access tickets 168 for multi-jurisdictional games, which may further enable access to win prizes from a combined progressive prize pool 212. As will be discussed in further detail herein, the combined progressive prize pool 212 may be managed by the multi-jurisdictional game management server 148, and the value of the combined progressive prize pool 212 may depend upon a current value of one or more individual progressive prize pools 208a, 208b, 208N. In some embodiments, each of the individual progressive prize pools 208a, 208b, 208N may corresponds to progressive prize pools for an individual jurisdiction 204a, 204b, 204N. For instance, a first progressive prize pool 208a may have a value determined based on tickets 168 purchased within a first jurisdiction 204a (e.g., via terminals 112 or mobile devices 160 in the first jurisdiction 204a or subject to regulations of the first jurisdiction 204a). The second progressive prize pool 208b may have a value determined based on tickets 168 purchased within a second jurisdiction 204b. The Nth progressive prize pool 208N may have a value determined based on tickets 168 purchased within the Nth jurisdiction 204N.

In some embodiments, the jurisdictional game management servers 116 may individually mange the progressive prize pools 208a, 208b, 208N and may report information about such prize pools to the multi-jurisdictional game management server 148. Alternatively or additionally, and as depicted in FIG. 2, the multi-jurisdictional game management server 148 may have access to the individual jurisdiction database 144, thereby enabling the multi-jurisdictional game management server 148 to determine current values of the individual progressive pools 208a, 208b, 208N. In yet another configuration, the multi-jurisdictional game management server 148 may be configured to manage a central multi-jurisdictional progressive prize pool, where contributions from tickets purchased in multiple jurisdictions are combined. Based on contributions from each jurisdiction, the multi-jurisdictional game management server 148 may determine a current value for the combined progressive pool 212. In some embodiments, the current value of the progressive prize pool 212 may include a combination of: (1) a value of one individual progressive pool 208 (e.g., a physical ticket prize pool at a time of referencing the electronic record of the combined progressive prize pool 212) and (2) a value of another progressive prize pool 208 (e.g., a digital ticket prize pool at the time of referencing the electronic record of the combined progressive prize pool 212). In some embodiments, the current value of the combined progressive prize pool 212 includes a full combination of values for two or more individual prize pools 208. In some embodiments, the current value of the combined progressive prize pool 212 includes a partial combination of values of two or more individual prize pools 208. In some embodiments, the game management instructions 136 of the multi-jurisdictional game management server 148 determine the value of two or more individual prize pools 208 (e.g., two different jurisdictional prize pools or two different types of prize pools such as a physical ticket prize pool and digital ticket prize pool), then generate an output based on the current value of the two or more prize pools, and then assign the output to the current value of the combined progressive prize pool 212.

As can be appreciated, the game management instructions 136 of the multi-jurisdictional game management server 148 may be configured to account for a number of different variables when determining a current value of the combined progressive pool 212. For example, the value of the combined progressive pool 212 depends on at least one of a jurisdiction in which a ticket 168 is purchased, a jurisdiction in which a particular prize pool is maintained, a number of tickets 168 sold in a particular jurisdiction, a number of tickets sold for a particular game, types of tickets 168 sold in a particular jurisdiction, and combinations thereof.

In embodiments where the combined progressive prize pool 212 accounts for values of digital ticket prize pool(s) and physical ticket prize pool(s), the value of the combined progressive prize pool 212 may depend on whether winning tickets were received from both pools. As an example, the prize value assigned by the game management instructions 136 to a winning ticket 168 may depend on whether a winning physical ticket and winning digital ticket are drawn for the same game. In such a situation, the winning physical ticket is assigned a prize value depending on the physical ticket prize pool and the winning digital ticket is assigned a prize value depending on the digital ticket prize pool. In other words, the prize value assigned to a particular ticket 168 may depend on a type of the ticket and whether other winning tickets of the same type or of a different type were drawn for a same game. As will be discussed in further detail herein, the game management instructions 136 of the multi-jurisdictional game management server 148 may be required to select between two or more tickets to determine a first winning ticket. The multi-jurisdictional game management server 148 may determine an earliest winning ticket from among a plurality of tickets by analyzing a time at which information describing a winning ticket was received at the server 148. It may also be possible to base the determination of a winning ticket on the time at which information describing the winning ticket is received at a server other than server 148. In other words, if arbitration is required between two or more different tickets, the decision on which ticket is awarded more or all of a progressive prize pool may depend on which ticket 168 had it's information first received at a server 148 (e.g., a time-of-receipt may be applied to determine a winner).

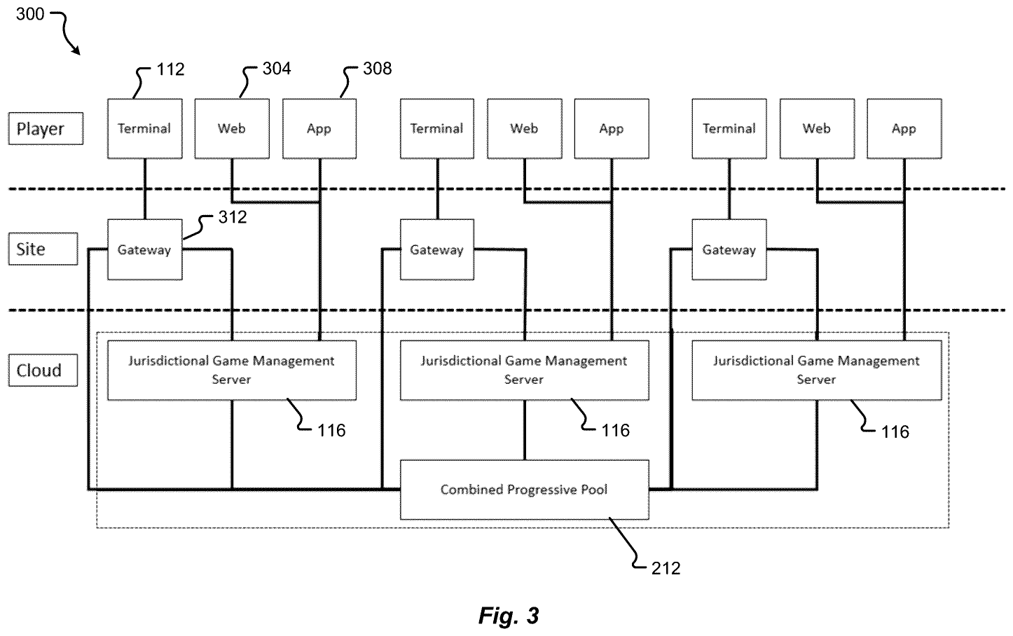

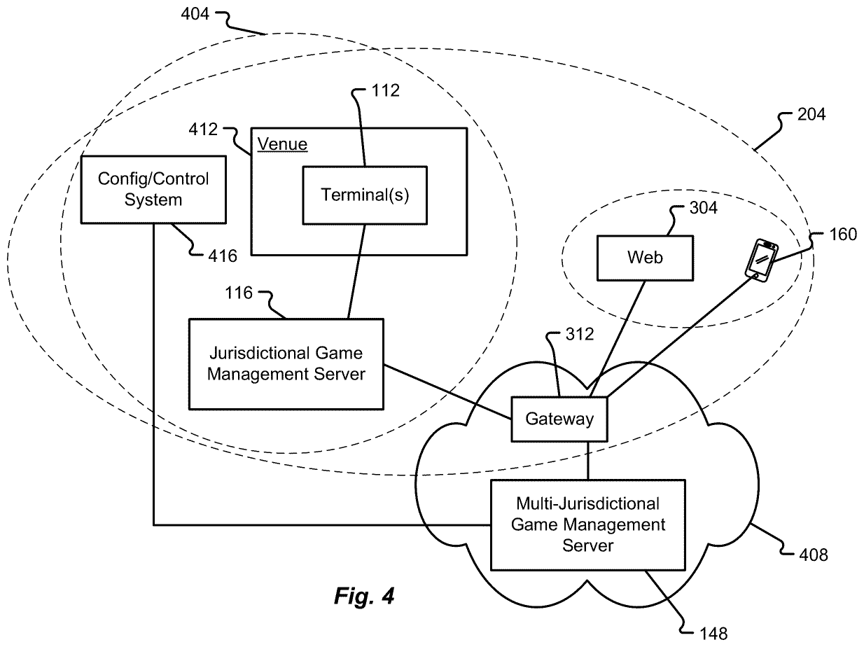

Referring now to FIGS. 3 and 4, additional details of an architecture 300 that enables a multi-jurisdictional game to be administered will be described. Similar to FIG. 2, FIG. 3 illustrates that a cloud-based architecture 300 can be used to coordinate jurisdictional game management servers 116 operating games for a particular jurisdiction 204. It should be appreciated that some or all of the jurisdictional game management servers 116 may interact with terminals 112 and mobile devices 160 to enable players 164 to purchase tickets 168 for one or many different types of games. While FIG. 3 illustrates a cloud-based architecture 300, it should be appreciated that any embodiment depicted and described herein may be deployed using any suitable type of architecture (e.g., not cloud-based, on-premises lottery engines, server/client architectures, etc.). It should be appreciated that the claims are not limited to a cloud-based architecture or cloud computing solutions.

The jurisdictional game management servers 116 may be accessed via a number of different channels. For instance, tickets 168 may be purchased directly via a web browser 304 or application 308 running on a client device (e.g., a mobile device 160). Alternatively or additionally, tickets 168 may be purchased via a terminal 112, which can communicate with the jurisdictional game management server 116 directly or via a gateway 312. In some embodiments, receipt information for ticket purchases may relate to when ticket purchase information is received at the jurisdictional game management server 116. In some embodiments, receipt information for ticket purchases may relate to when a gateway 312 or terminal 112 completes a purchase for a ticket. Thus, access to prizes for the combined progressive pool 212 may depend on time of ticket receipt at the multi-jurisdictional game management server 148.

Again, winning tickets can be determined based on time of ticket receipt at the multi-jurisdictional game management server 148. Thus, each jurisdiction 204 may be required to agree that time of receipt is not applied based on machines within the jurisdiction 204, but rather that time of receipt is applied based on time of receipt at the multi-jurisdictional game management server 148 (e.g., for purposes of determining which winning ticket gets access to a current value from a combined progressive pool 212). This may cause each jurisdiction 204 to try and optimize communication/network speeds between their jurisdictional game management server 116 and the multi-jurisdictional game management server 148.

Terminals 112 at venues 412 within a particular jurisdiction 204 may communicate directly with the jurisdictional game management server 116. Such terminals 112 may be considered installed within installation sites 404 specific to a jurisdiction 204. As mentioned above, jurisdictions 204 may also enable mobile or digital ticket 168 purchases via web browsers 304 and/or applications 308 on a mobile device 160.

In some embodiments, the multi-jurisdictional game management server 148 may be administered and controlled by a configuration/control system 416, which may be installed and operated within a particular installation side 404. It should be appreciated that multiple configuration/control systems 416 may be provided, but interfaces and changes to the multi-jurisdictional game management server 148 may be limited to individuals having valid access permissions (e.g., may be authentication-based). As changes to game rules within a particular jurisdiction or to the multi-jurisdiction game are made, such changes may be reported to all other jurisdictional game management servers 116 in various jurisdictions 204.

Alternative mechanisms for coordinating multiple jurisdictions 204 may also be provided. While some embodiments consider that coordination is performed at the multi-jurisdictional game server 148, it is possible to deploy some coordination to each jurisdiction. As will be described in further detail herein, each jurisdictional game management server 116 may be configured to keep track of its contribution to the jackpot at the combined progressive pool 212 by the second. The game engines (e.g., game management instructions 136 at each server 116) can report their contribution to the jackpot at the end of every second. If a draw game engine hits the jackpot it will request the payout from the multi-jurisdictional game management server 148 given the exact second the jackpot was hit. The multi-jurisdictional game management server 148 may then wait until all draw game engines have reported the contribution to the jackpot up until the second that the jackpot was hit. Once the multi-jurisdictional game management server 148 has received all contribution it will tell the winning draw game engine the amount and reset the jackpot of the combined progressive pool 212. The alternative approach, of course, is that all contributions are determined and added at the multi-jurisdictional game management server 148.

While embodiments consider that there will always be a first winning ticket and no second winning ticket at the same time as the first winning ticket, other embodiments contemplate that jackpots can be split. In some embodiments, if two engines hit the jackpot in the exact same second they can share the jackpot from the combined progressive pool 212. If all draw game engines do not report in a reasonable time after a jackpot payout request has been received, the multi-jurisdictional game management server 148 can respond, jackpot won but no amount at this point.

A possible architecture provides the advantage of minimizing latency for the network and minimizing latency to the wager flow. This occurs since the game engines do not need to call the centralized multi-jurisdictional game management server 148 inside the wager flow. Moreover, a site does not need to stop sales if it loses communication with the multi-jurisdictional game management server 148 or if the multi-jurisdictional game management server 148 is having problems. Performance issues are also avoided as each jurisdiction 204 is only making one call every second to the multi-jurisdictional game management server 148. Furthermore, multi-jurisdictional game management server 148 can be used on other high performing games and can run on very limited resources and serve many customers. In other embodiments, the contributions to a progressive pool may be incorporated into the wager flow. This approach will help to make the contributions to the progressive prize pool more efficient.

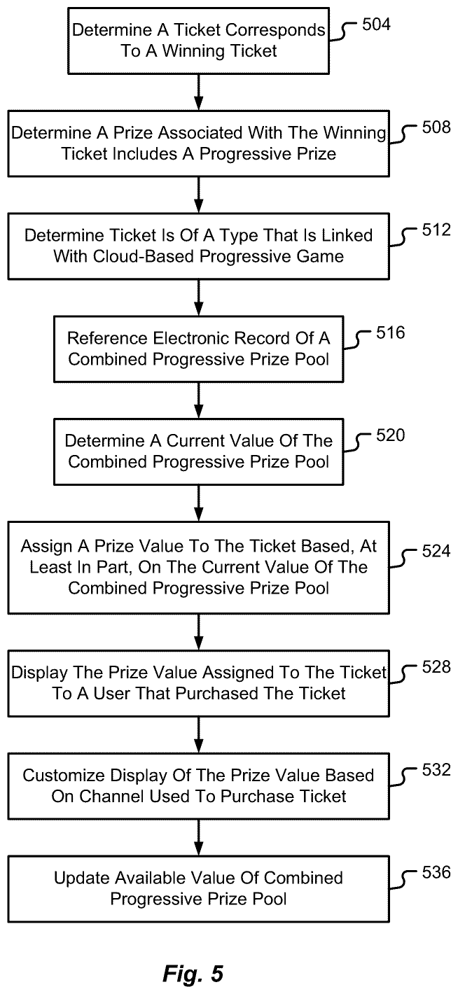

With reference now to FIGS. 5-7, various methods of operating components of a system 100 will be described herein. It should be appreciated that any of the methods or the method steps depicted and described herein can be performed by any device depicted and described herein and may be performed in an order other than the order depicted. Moreover, steps from one method may be performed in another method without departing from the scope of the present disclosure.

With reference initially to FIG. 5, a first method will be described in accordance with at least some embodiments of the present disclosure. The method begins when ticket data 172 is received at game management instructions 136 and the game management instructions 136 determine that the ticket 168 associated with the ticket data 172 corresponds to a winning ticket (step 504). The determination may be made using game management instructions 136 of the jurisdictional game management server 116 and/or game management instructions 136 of the multi-jurisdictional game management server 148.

The method continues with the game management instructions 136 further analyzing the ticket data 172 to determine a prize associated with the winning ticket is a progressive prize (step 508). Alternatively or additionally, the payout reconciliation instructions 140 and/or multi-jurisdictional payout instructions 152 may be invoked to determine that the ticket 168 was purchased for an opportunity to win a progressive prize. Analysis of the ticket data 172 may identify which progressive prize pool(s) 208, 212 the ticket 168 was eligible to receive an award from. In some embodiments, the ticket data 172 may include a link or identifier of the progressive prize pool(s) 208, 212 to which the ticket 168 is linked.

Analysis of the ticket data 172 may also reveal that the ticket 168 is of a type that is linked with a cloud-based progressive game (step 512). In other words, the ticket 168 may be of a type that is linked with a combined progressive pool 212, meaning that the progressive prize won by the ticket 168 will have a value determined by a current value of the combined progressive pool 212. Alternatively or additionally, the progressive prize awarded to the winning ticket may include funds from a jurisdictionally-unique progressive pool 208.

Based on determining that the ticket 168 is a winning ticket, is entitled to a progressive prize, and that the progressive prize may be obtained from the combined progressive pool 212, the method continues by referencing an electronic record associated with the combined progressive pool 212 (step 516). In some embodiments, the multi-jurisdictional payout instructions 152 are invoked to reference the multi-jurisdictional wager management database 156 to determine a current value of the combined progressive pool 212 (step 520). In some embodiments, the current value of the combined progressive pool 212 may be pre-calculated and reported directly to the multi-jurisdictional payout instructions 152. In some embodiments, the multi-jurisdictional payout instructions 152 may need to determine current values of one or more individual progressive pools 208a-N to determine a current value of the combined progressive pool 212 and to determine the progressive prize to award to the winning ticket 168. As can be appreciated, the progressive prize awarded to the winning ticket 168 may depend upon a time at which the ticket data 172 for the winning ticket 168 was received at the multi-jurisdictional game management server 148. Such information may be obtained with reference to progressive data 176 from multiple different individual jurisdiction databases or by referencing progressive data 176 in the multi-jurisdictional wager management database 156. The value of the combined progressive pool 212 at a time coinciding with receipt of the ticket data 172 may correspond to the prize value that is eventually assigned to the winning ticket 168.

The multi-jurisdictional payout instructions 152 will continue by cooperating with the game management instructions 136 to assign a prize value to the winning ticket 168 (step 524). In some embodiments, the prize value assigned to the winning ticket 168 corresponds to all of the current value of the combined progressive pool 212. In some embodiments, the prize value assigned to the winning ticket 168 corresponds to a portion of the current value of the combined progressive pool 212.

The method then continues by optionally invoking a process to notify the player 164 that they have purchased a winning ticket 168 and to further notify the player 164 of the prize value assigned to the ticket 168 (step 528). In some embodiments, the winning ticket notification and information about the prize value assigned to the ticket 168 may be presented to the player 164 via a display on their mobile device 160. If the player 164 purchased a physical ticket, then the notification may further include determining a communication channel over which to communicate with the player 164 (e.g., email, text, phone call, etc.).

In some embodiments, the method may further include customizing the display of the prize value to the player 164 based on the communication channel used to purchase the ticket (step 532). For example, the player 164 may receive one type of notification if the ticket 168 corresponds to a physical ticket and may receive a different type of notification if the ticket 168 corresponds to a digital ticket. In some embodiments, if the ticket 168 is a digital ticket and the player 164 purchased the ticket 168 using an application 308 on their mobile device 160, then the notification may include providing a push notification to the mobile device 160 through the application 308. If the digital ticket 168 was purchased via another channel (e.g., via a web browser 304), then the notification may include emailing, texting, browser notifications, pop-up notifications, or calling the mobile device 160 of the player 164.

The method may further include updating the available value of the combined progressive pool 212 based on some or all funds of the combined progressive pool 212 being awarded to the winning ticket 168 (step 536). In some embodiments, the combined progressive pool 212 may be reset to a predetermined value. In some embodiments, the combined progressive pool 212 may be decremented by the prize value awarded to the winning ticket 168.

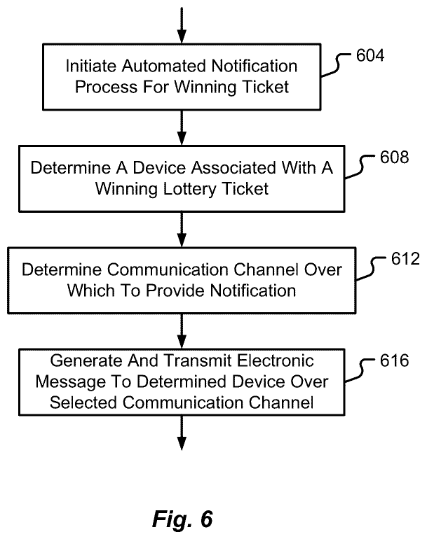

Referring now to FIG. 6, details of a second method will be described in accordance with at least some embodiments of the present disclosure. Steps of the method may be performed in any appropriate order and may be combined with one or more steps of any other method depicted and described herein.

The method begins when a winning ticket 168 has been identified and a process is initiated to automatically notify the player 164 associated with the winning ticket 168 (step 604). The automated notification process may be initiated immediately upon identifying a winning ticket 168 has been purchased or upon identifying that a winning ticket 168 has been redeemed.

The method continues by determining a device associated with the winning ticket 168 (step 608). In some embodiments, the device associated with the winning ticket 168 may correspond to the device used to purchase the ticket 168 (e.g., a mobile device 160 used by the player 164 to purchase the ticket 168 or a device having an IP address used to purchase the ticket 168). Alternatively, the determination of the device may include referencing ticket data 172 that may include contact information for the player 164 that purchased the ticket 168.

The method continues by determining a communication channel over which to provide the notification (step 612). The determination of a communication channel may include identifying one or multiple communication channels. The selection of a communication channel may also depend on the capabilities of the device identified in step 608.

The method then continues by generating and transmitting an electronic message to the determined device over the determined communication channel(s) (step 616). In some embodiments, the game management instructions 136 may cooperate with the client interface 132 to transmit the electronic message to the determined device. In some embodiments, the electronic message may include one or more of a push notification, an email, a text, or an automatically dialed number followed by playing of an automated recording.

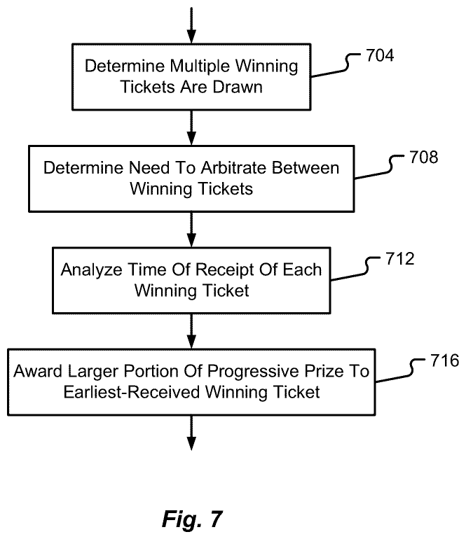

Referring now to FIG. 7, details of a third method will be described in accordance with at least some embodiments of the present disclosure. Steps of the method may be performed in any appropriate order and may be combined with one or more steps of any other method depicted and described herein.

The method may be invoked when it is determined that multiple winning tickets have been drawn, purchased, or redeemed (step 704). In situations where the multiple tickets both have access to the combined progressive pool 212 and the tickets were drawn, purchased, or redeemed at the same time (e.g., within the same second), then the prize value from the combined progressive pool 212 may be equally divided between the multiple winning tickets.

If, however, two or more of the winning tickets were not drawn, purchased, or redeemed at the same time, then it may become necessary to arbitrated between the winning tickets (step 708). Arbitration between the multiple tickets may include analyzing a time of receipt of each winning ticket (step 712). In some embodiments, the time of receipt may be determined by a receipt timestamp generated by the multi-jurisdictional game management server 148 that is coordinating the multi-jurisdictional game between jurisdictions 204a-N.

The multi-jurisdictional payout instructions 152 may arbitrate between the winning tickets by awarding the larger portion of the combined progressive pool 212 to the earliest-received winning ticket (step 716). In some embodiments, the earliest-received winning ticket may receive all funds from the combined progressive pool 212, then the next-received winning ticket may receive funds from the combined progressive pool 212 after the pool 212 has been automatically reset to a new value (e.g., after the first funds were awarded to the earliest-received winning ticket).

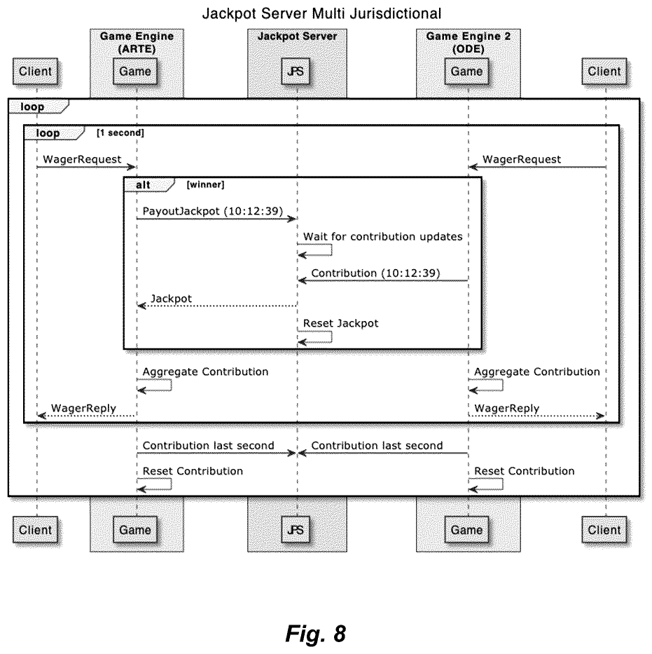

As can be seen in FIG. 8, multiple different clients from different jurisdictions 204 may communicate with their respective jurisdictional game management server 116 (shown as a game engine and game engine 2). In the illustrated example of FIG. 8, the first game engine may be part of a jurisdictional game management server 116 in a first jurisdiction 204a and the second game engine may be part of a jurisdictional game management server 116 in a second jurisdiction 204b. Both game engines are enabled to communicate with the multi-jurisdictional game management server 148 (shown as a Jackpot Server).

FIG. 8 further shows how different clients can issue different wager requests to the appropriate game engine in their jurisdiction. Upon receiving the wager requests, the first game engine registered a progressive prize payout and appropriately notifies the Jackpot Server that a jackpot payout is required from the combined progressive pool 212. If the Jackpot Server received one jackpot payout notification from one game engine, the Jackpot Server will wait for contribution updates for a predetermined amount of time (e.g., one second). After the predetermined amount of time has passed and contribution amounts have been updated (e.g., based on wager requests from other jurisdictions within the predetermined amount of time), then the jackpot may be awarded to the winning ticket identified in the jackpot payout message.

Each participating game will keep track of its contribution to the jackpot by the same predetermined time intervals (e.g., by the second). The game engines will report their contribution to the jackpot at the end of every second. Once the Jackpot Server has received all contributions for the predetermined time interval, it will tell the winning draw game engine the prize amount and reset the jackpot.

As previously mentioned, if two engines hit the jackpot in the exact same moment, a winner may still be determined based on which engine's ticket report reached the multi-jurisdictional server 148 first (e.g., applying a first-in-first-win allocation approach). Such an approach helps to avoid downstream claim issues. Alternatively, it may be possible that tickets from the two different engines can share the jackpot. If all draw game engines do not report in a reasonable time after a jackpot payout request has been received at the Jackpot Server, the Jackpot Server can respond to the jackpot payout request that a jackpot has been won, but the progressive prize value is undetermined at the current time.

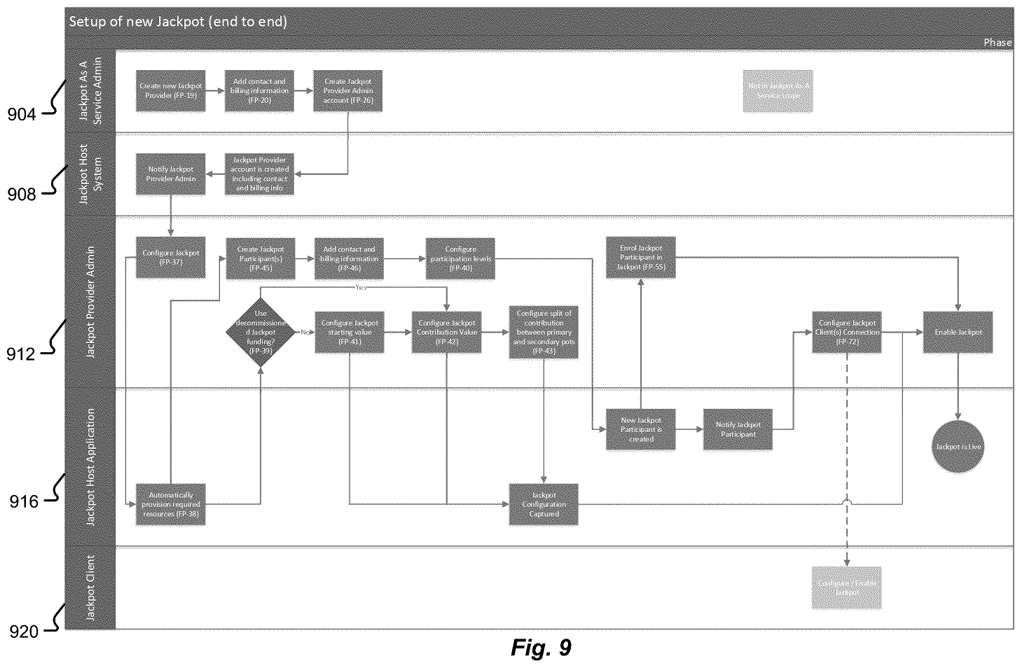

Referring now to FIG. 9, additional details of setting up a multi-jurisdictional progressive game will be described in accordance with at least some embodiments of the present disclosure. The setup process may include a number of steps that can be performed in any suitable order. The steps of the setup process may be performed by a number of different entities within the system 100. Illustrative entities that may perform the setup process include a jackpot-as-a-service administrator 904, a jackpot host system 908, a jackpot provider administrator 912, a jackpot host application 916, and a jackpot client 920.

The jackpot-as-a-service administrator 904 may, in one example, correspond to a configuration/control system 416 that communicates directly with the multi-jurisdictional game management server 148. The jackpot host system 908 may, in one example, correspond to the multi-jurisdictional game management server 148 or a component thereof. The jackpot provider administrator 912 may, in one example, correspond to a jurisdictional game management server 116. The jackpot host application 916 may, in one example, correspond to instructions (e.g., the client interface 132, the game management instructions 136, and/or multi-jurisdictional payout instructions 152) residing on the multi-jurisdictional game management server 148. The jackpot client 920 may, in one example, correspond to any one of the client devices depicted and described herein (e.g., gaming machine 108, terminal 112, mobile device 160, web browser 304, application 308, client, etc.). Alternatively or additionally, the jackpot client 920 may correspond to a jurisdictional game management server 116.

In some embodiments, the jackpot setup may start when the jackpot-as-a-service administrator 904 creates a new jackpot provider (FP-19), which may include adding contact and billing information (FP-20), then creating a new jackpot provider administrator account for the jackpot provider (FP-26). In some embodiments, the multi-jurisdictional game management server 148 may be responsible for initially creating a new jackpot provider account, which may then provide a jurisdictional game management server 116 with the ability to issue tickets in connection with the multi-jurisdictional game. Once a provider account is created, the jurisdictional game management server 116 may be allowed to interact with the multi-jurisdictional game management server 148 and provide contributions to a combined progressive pool 212.

In some embodiments, the jackpot setup may continue with the jackpot host system 908 notifying the jackpot provider administrator 912 that an account has been created for the jackpot provider. With the jackpot provider account now created, the jackpot provider administrator 912 may be allowed to configure its jackpot within its own jurisdiction (FP-37). The configuration of the jackpot by the jackpot provider administrator 912 may comply with at least some configuration rules defined by the multi-jurisdictional game management server 116, but other rules not defined by the multi-jurisdictional game management server 148 may be defined uniquely by the jurisdictional game management server 116 for tickets issued within its jurisdiction.

In some embodiments, the jackpot setup may include having the jackpot provider administrator communicate with the jackpot host application 916 for purposes of automatically provisioning required resources (FP-38). The setup may also include, creating jackpot participants (FP-45) within the jackpot provider domain (e.g., within a specific jurisdiction). The jackpot setup may also include determining if decommissioned jackpot funding can be used (FP-39). If decommissioned jackpot funding cannot be used, then the jackpot starting value may be initially configured (FP-41). Thereafter, or if the decommissioned jackpot funding can be used, then setup includes configuring the jackpot contribution value for the provider (FP-42). The setup may also include configuring splits of contribution between primary and secondary progressive pools (FP-43). The configuration of this step may then be provided to the jackpot host application 916, which captures the jackpot configuration for the jackpot provider administrator 912.

Meanwhile, as another part of the jackpot setup, the jackpot provider administrator 912 may create jackpot participants (FP-45) by adding contact and billing information for such participants (FP-46). The jackpot provider administrator 912 may also configure participation levels for the jackpot participants (FP-40), then inform the jackpot host application 916 that new jackpot participants have been created.

This may trigger two separate processes of enrolling the new participant in the jackpot (FP-55) as well as notifying the new jackpot participants of their enrollment. Once jackpot participants have been notified, the setup process may further include configuring jackpot client connections between jackpot participants, jackpot providers, and/or the jackpot host application 912. Once client connections have been configured, then clients may be allowed access to the multi-jurisdictional jackpot (e.g., the combined progressive pool 212), meaning that tickets for game(s) allowing access to the combined progressive pool 212 are now printable and sellable. At this point the jackpot is live and may be accessed by the jackpot participants.

The present disclosure contemplates a variety of different systems each having one or more of a plurality of different features, attributes, or characteristics. A “system”, “gaming system”, or “lottery system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices.

In certain embodiments in which the system includes: (a) a device configured to communicate with a central server, central controller, or remote host through a data network; and/or (b) a plurality of devices configured to communicate with one another through a communication network, which may be distributed in nature.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The invention is claimed as follows:

1. A gaming system server, comprising:
at least one processor; and
at least one memory device that stores instructions, which when executed by the at least one processor, cause the at least one processor to:
determine a lottery ticket corresponds to a winning lottery ticket;
determine a prize associated with the winning lottery ticket includes a progressive prize;
determine the lottery ticket corresponds to a type of lottery ticket that links a physical ticket prize pool with a digital ticket prize pool;
in response to determining that the lottery ticket corresponds to the winning lottery ticket, includes the progressive prize, and corresponds to a type of lottery ticket that links a physical ticket prize pool with a digital ticket prize pool, reference an electronic record of a progressive prize pool for linked tickets;
based on referencing the electronic record of the progressive prize pool for linked tickets, determine a current value of the progressive prize pool for linked tickets; and
assign a prize value to the lottery ticket based on the current value of the progressive prize pool for linked tickets.

2. The gaming system server of claim 1, wherein the prize value assigned to the lottery ticket includes an entirety of the current value of the progressive prize pool for linked tickets.

3. The gaming system server of claim 1, wherein the prize value assigned to the lottery ticket includes a portion of the current value of the progressive prize pool for linked tickets.

4. The gaming system server of claim 1, wherein the current value of the progressive prize pool for linked tickets comprises a combination of: (1) a value of the physical ticket prize pool at a time of referencing the electronic record of the progressive prize pool for linked tickets and (2) a value of the digital ticket prize pool at the time of referencing the electronic record of the progressive prize pool for linked tickets.

5. The gaming system server of claim 4, wherein the current value of the progressive prize pool for linked tickets comprises a full combination of the value of the physical ticket prize pool and the value of the digital ticket prize pool.

6. The gaming system server of claim 4, wherein the current value of the progressive prize pool for linked tickets comprises a partial combination of the value of the physical ticket prize pool and the value of the digital ticket prize pool.

7. The gaming system server of claim 6, wherein the instructions further cause the at least one processor to:
provide the value of the physical ticket prize pool and the value of the digital ticket prize pool to a linked ticket management instruction set;
receive, from the linked ticket management instruction set, an output generated based on the current value of the progressive prize pool for linked tickets; and
assign the output to the current value of the progressive prize pool for linked tickets.

8. The gaming system server of claim 7, wherein the output depends on at least one of a jurisdiction in which the lottery ticket is purchased, a jurisdiction in which the physical ticket prize pool is maintained, and a jurisdiction in which the digital ticket prize pool is maintained.

9. The gaming system server of claim 6, wherein the lottery ticket is associated with a particular game, wherein the value of the physical ticket prize pool depends on a number of physical tickets sold for the particular game, and wherein the value of the digital ticket prize pool depends on a number of digital tickets sold for the particular game.

10. The gaming system server of claim 1, wherein the prize value assigned to the lottery ticket depends on whether a winning physical ticket is also drawn and whether a winning digital ticket is also drawn, wherein the winning physical ticket is assigned a prize value depending on the physical ticket prize pool, and wherein the winning digital ticket is assigned a prize value depending on the digital ticket prize pool.

11. A method, comprising:
determining, with a processor, a lottery ticket corresponds to a winning lottery ticket;
determining, with the processor, a prize associated with the winning lottery ticket includes a progressive prize;
determining, with the processor, the lottery ticket corresponds to a type of lottery ticket that links a physical ticket prize pool with a digital ticket prize pool;
in response to determining that the lottery ticket corresponds to the winning lottery ticket, includes the progressive prize, and corresponds to a type of lottery ticket that links a physical ticket prize pool with a digital ticket prize pool, referencing an electronic record of a progressive prize pool for linked tickets;
based on referencing the electronic record of the progressive prize pool for linked tickets, determining, with the processor, a current value of the progressive prize pool for linked tickets; and
assigning, with the processor, a prize value to the lottery ticket based on the current value of the progressive prize pool for linked tickets.

12. The method of claim 11, further comprising:
displaying, via a user interface of a computational device, the prize value assigned to the lottery ticket, wherein the computational device comprises an electronic record indicating that a user purchased the lottery ticket with the computational device.

13. The method of claim 11, further comprising:
determining a computational device associated with the lottery ticket; and
in response to assigning the prize value to the lottery ticket, automatically transmitting an electronic message to the computational device that indicates the prize value assigned to the lottery ticket.

14. The method of claim 11, wherein the progressive prize pool for linked tickets is different from the physical ticket prize pool and is different from the digital ticket prize pool, and wherein the prize value assigned to the lottery ticket includes an entirety of the current value of the progressive prize pool for linked tickets.

15. The method of claim 11, wherein the physical ticket prize pool comprises a first progressive prize pool, wherein the digital ticket prize pool comprises a second progressive prize pool, and wherein a size of the progressive prize pool for linked tickets depends, at least in part, on a size of the first progressive prize pool and a size of the second progressive prize pool.

16. The method of claim 11, wherein the current value of the progressive prize pool for linked tickets comprises a combination of: (1) a value of the physical ticket prize pool at a time of referencing the electronic record of the progressive prize pool for linked tickets and (2) a value of the digital ticket prize pool at the time of referencing the electronic record of the progressive prize pool for linked tickets.

17. The method of claim 16, wherein the lottery ticket is associated with a particular game, wherein a value of the physical ticket prize pool depends on a number of physical tickets sold for the particular game, and wherein the value of the digital ticket prize pool depends on a number of digital tickets sold for the particular game.

18. The method of claim 11, wherein the prize value assigned to the lottery ticket depends on whether a winning physical ticket is also drawn and whether a winning digital ticket is also drawn, wherein the winning physical ticket is assigned a prize value depending on the physical ticket prize pool, and wherein the winning digital ticket is assigned a prize value depending on the digital ticket prize pool.

19. The method of claim 11, wherein the lottery ticket comprises a digital ticket with ticket information generated at a time of purchasing the ticket.

20. A system, comprising:
a processor; and
computer memory comprising instructions stored thereon that are executable by the processor, wherein the instructions include instructions that:
automatically reference an electronic record of a progressive prize pool for linked tickets at a reference time in response to determining a lottery ticket: (1) corresponds to a winning lottery ticket, (2) includes a progressive prize, and (3) corresponds to a type of lottery ticket that links a physical ticket prize pool with a digital ticket prize pool;
based on referencing the electronic record of the progressive prize pool for linked tickets, determine a value of the progressive prize pool for linked tickets at the reference time;
assign a prize value to the lottery ticket based on the value of the progressive prize pool for linked tickets at the reference time;
automatically update an electronic record associated with the lottery ticket to include the prize value assigned thereto; and
automatically decrease the progressive prize pool for linked tickets by the prize value.
